(19) United States
(12) Patent Application Publication
(10) Pub. No.: US 2002/0060462 A1
(43) Pub. Date: May 23, 2002

(54) Bumper beam absorber

(76) Inventor: Patrick M. Glance, Plymouth, MI (US)

Correspondence Address: Waters & Morse, P.C., 400 Ledyard Building, 125 Ottawa, Avenue, NW, Grand Rapids, MI, 49503, US

(21) Appl. No.: 09/879,768

(22) Filed: Jun. 12, 2001

Related U.S. Application Data
(63) Continuation-in-part of application No. 09/313,886, filed on May 18, 1999.
(60) Provisional application No. 60/211,008, filed on Jun. 12, 2000.
(60) Provisional application No. 60/091,587, filed on Jul. 2, 1998.

(51) Int. Cl. B32B 1/08; B32B 1/02; B65D 1/00

(52) U.S. Cl. 293/120; 428/34.1; 428/71

(57) ABSTRACT

A bumper having improved energy absorbing characteristics comprises an elongated rigid beam having an energy absorber mounted thereto. The energy absorber is integrally formed of a moldable resin and includes a base having a plurality of inverted cup shaped cells formed on at least one side thereof. The cells have a circular cross section and employ thin wall construction with a desirable aspect ratio of height to width to wall thickness, with the height of the cells being substantially greater than the width of the cells. An energy absorber is positioned inside a hollow box beam to provide improved energy absorption and crush resistance at higher vehicle speeds.

### CROSS-REFERENCES TO RELATED APPLICATIONS

This application is based on and claims the benefit of the filing date of applicant's copending provisional application Serial No. 60/211,008, filed Jun. 12, 2000. This application is also a continuation-in-part of applicant's co-pending non-provisional patent application Ser. No. 09/313,/886, filed May 18, 1999, which is in turn based on provisional application Serial No. 60/091,587, filed Jul. 2, 1998.

### STATEMENT REGARDING FEDERALLY SPONSORED RESEARCH OR DEVELOPMENT

Not Applicable.

### BACKGROUND OF THE INVENTION

Current automotive bumper construction typically includes a rigid bumper beam constructed of various structural materials, including and not limited to metals and plastics. The bumper beam may commonly be a hollow, closed section member. Some beams are reinforced with ribs or an internal bulkhead or other stiffening reinforcement. The use of these reinforcements often prevent bumper beam crush, at least locally, during high speed impact. This in turn represents lost crush space and energy absorption for high speed impacts. There is a need to provide internal bumper beam reinforcement for low speed (5 mph) impacts and provide controlled beam crush at higher speed impacts.

Applicant's co-pending application Ser. No. 09/313,886, which is incorporated by reference, discusses a plastic cone-shaped energy absorber and applications for bumper and impact surface energy absorption. The cone absorber in that application has a normal application for a front face bumper absorber to manage 5 mph impacts. In the present invention the plastic cone absorber can also be packaged inside a hollow metal bumper beam. Hollow extruded aluminum bumper beams with internal ribs are currently in production. Sometimes a foam absorber is employed in the beam.

### BRIEF SUMMARY OF THE INVENTION

In accordance with the present invention, a bumper for a motor vehicle comprises a bumper beam and an energy absorber mounted to the bumper beam in position to absorb a horizontal impact load directed against the bumper. The energy absorber is integrally formed of material comprising resilient moldable plastic resin and comprises a base sheet having a plurality of spaced inverted cup-shaped energy absorbing cells integrally formed therein. The cells have a top end positioned away from the base sheet and an open bottom end and have relatively thin sidewalls extending downwardly and outwardly between the top and the bottom. The cells have a generally circular cross section and are resiliently collapsible in an axial direction when subjected to an axial impact load. The energy absorber is constructed and mounted such that the energy absorption of the energy absorber is attributable substantially exclusively to the resilient collapse of the cell sidewalls and not to air compression within the cells.

An important feature of the present invention is that the cells have thin sidewalls (which desirably are less than 2 mm and preferably 1 mm or perhaps less). The cells are substantially higher than they are wide and preferably have an aspect ratio of height to width to thickness of about 1.8, subject to some variation or operating conditions, vehicle requirements, absorber materials and the like.

While it is desirable to place an energy absorber of the present invention on the front of the beam, it is also desirable to place an energy absorber inside the beam. The beam can be a so-called box beam having a continuous peripheral side wall and providing a substantially rectangular internal opening with substantially parallel front and back walls.

Placing an energy absorber of the type described on the front of the bumper beam provides resilient energy absorption up to about 5 mph, while an energy absorber inside a hollow beam provides energy absorption and beam crush resistance for higher vehicle speeds up to about 35 mph.

During high speed impacts, the absorber is designed to collapse and provide valuable controlled energy absorption. Because the plastic cone is highly velocity sensitive, it will automatically produce a higher force of collapse during high speed impacts. This is a desirable feature for automotive safety design engineers.

The velocity sensitivity of the present cone absorber is approximately a factor of ten. This means the force produced during a 5 mph impact will be ten times higher at 20 mph.

The cone internal bumper absorber represents a low cost light weight method to add internal reinforcement and controlled energy absorption to a bumper beam.

These and other advantages and features of the present invention are described below and shown in the attached drawings.

### BRIEF DESCRIPTION OF THE SEVERAL VIEWS OF THE DRAWING

FIG. 1 is a cross-sectional view of a bumper of the invention;

FIG. 2 is an isometric wire-line drawing of a hollow bumper beam shell of the invention;

FIG. 3 is a fragmentary perspective view of a portion of an absorber insert of the invention;

FIG. 4 is a side elevational view thereof;

FIG. 5 is an end elevational view thereof;

FIG. 6 is a top plan view thereof;

FIG. 7 is a graphic plot of the Force vs. Displacement characteristics of a bumper of the invention; and

FIG. 8 is the view of FIG. 3, showing a first alternative absorber insert.

### DETAILED DESCRIPTION OF THE INVENTION

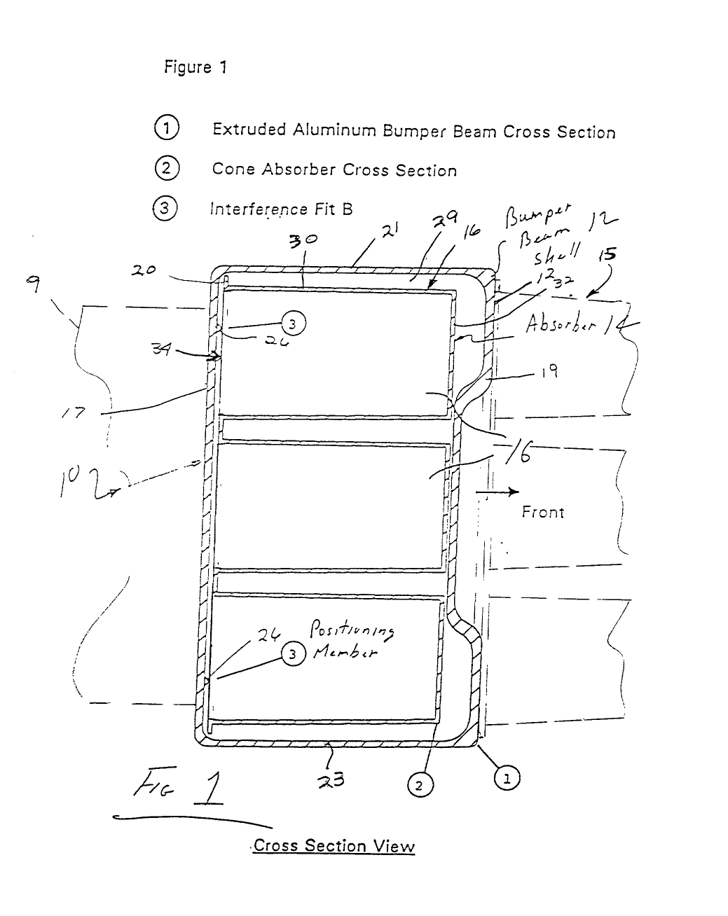

Referring to the drawings, a vehicle bumper 10 constructed in accordance with the present invention comprises an elongated rigid bumper beam or shell 12 and an internal bumper beam energy absorber 14. The bumper also can include an energy absorber 15 on a front face of the beam, as shown schematically in FIG. 1.

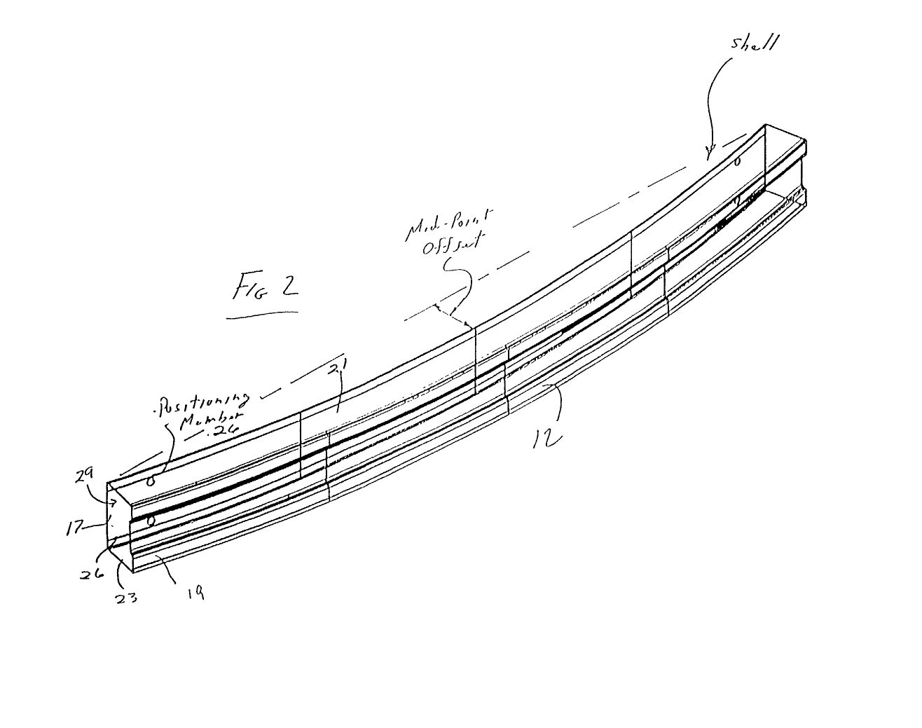

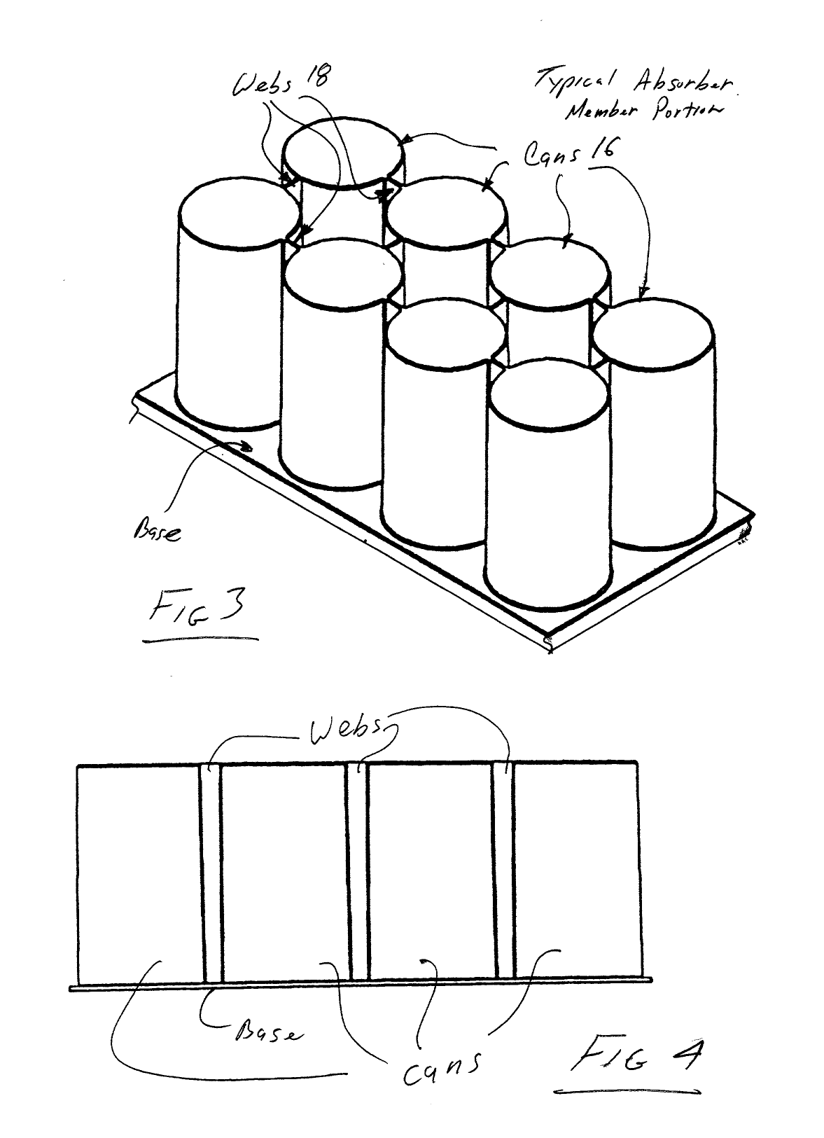

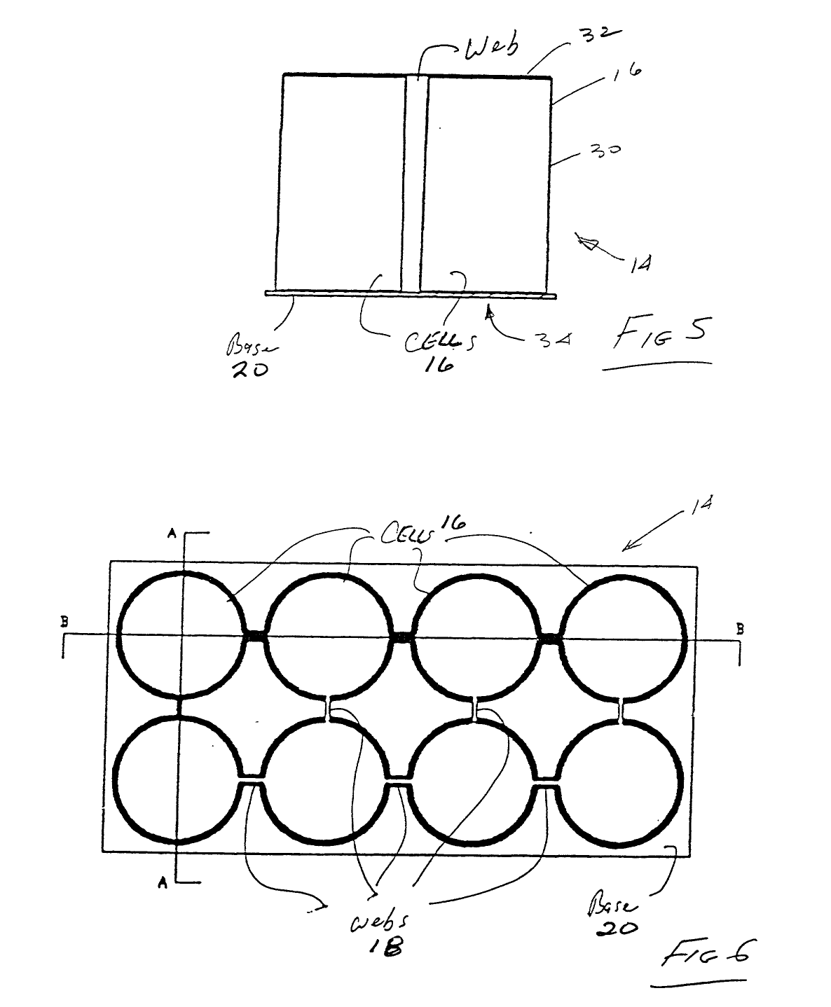

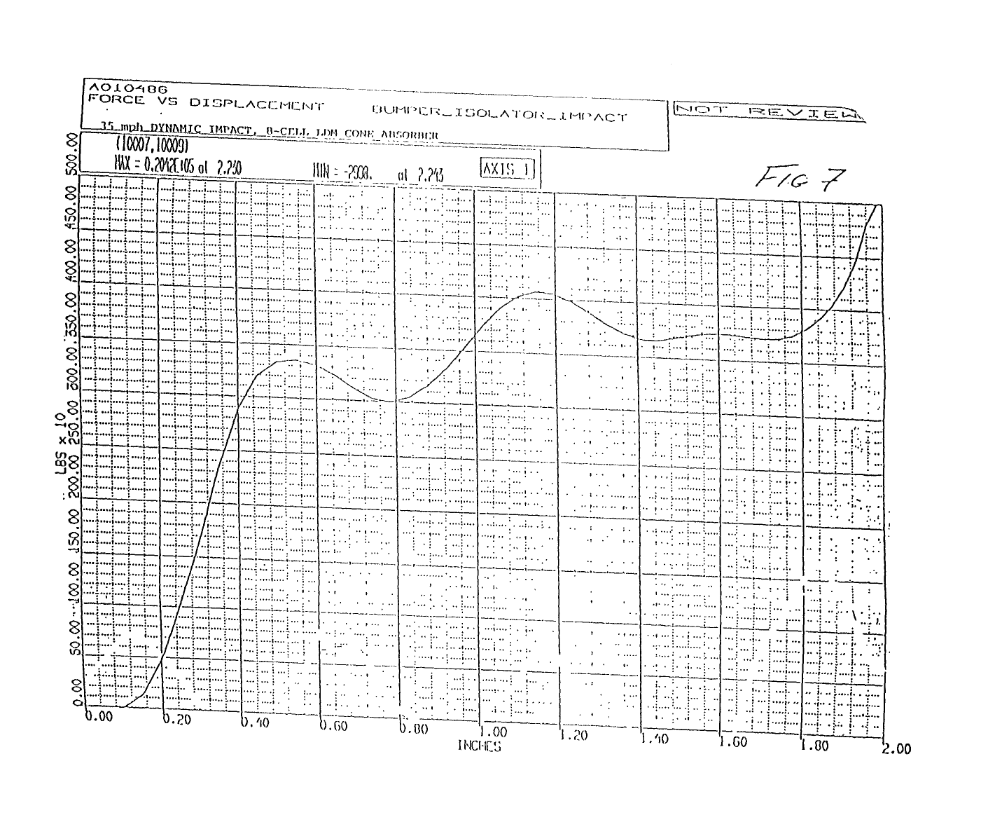

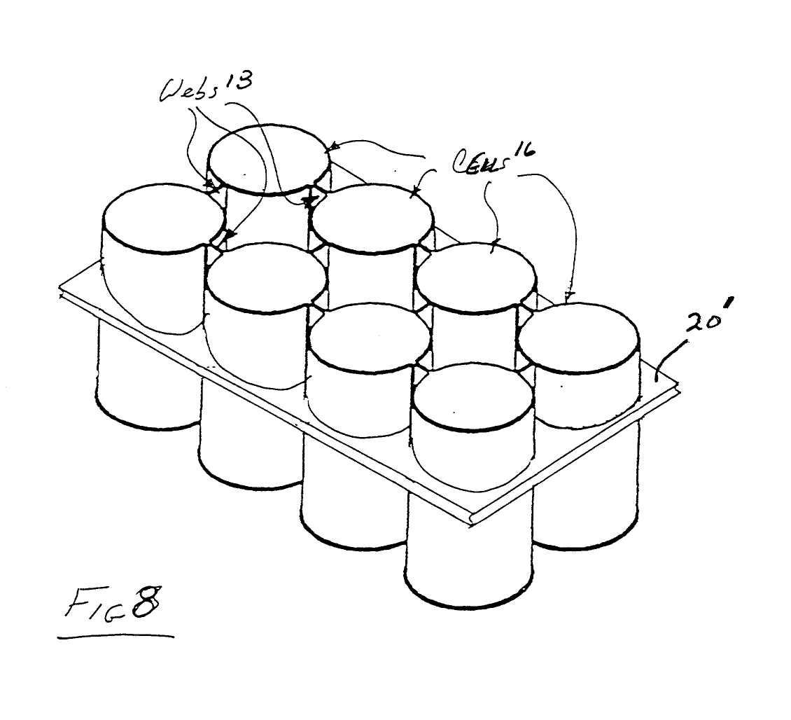

Beam 12 is a rigid member formed of aluminum, steel, or other appropriate bumper beam material. An extruded aluminum beam is generally preferred. A roll formed metal beam also could be employed. Beam 12 has a generally rectangular shape with a vertical rear wall 17, a generally vertical front wall 19 and upper and lower walls 21 and 23, with the walls constituting walls of a closed box beam. Positioning members 26 (shown in FIGS. 1 and 2) extend along the inner surface of wall 17 in order to provide a snug friction fit for the energy absorber 14 so as to cause the energy absorber to be snugly secured inside the opening 29 in the beam.

The energy absorber employed in the present invention can be substantially the same as the energy absorber employed in applicant's copending application Ser. No. 09/313,886. In the preferred practice of the invention, the absorber comprises a flat base 20 having a plurality of cells or cans 16 extending at right angles therefrom over the surface of the base, with the cells being spaced relatively closely, with at least certain of the cells being interconnected by horizontal or vertical ribs or webs 18 that extend between the cells. The ribs reinforce the cells against lateral movement. The ribs are removed in at least some locations if the cells are to be positioned in a bumper beam having a plan view sweep (i.e. arcuate configuration), as shown in FIG. 2, so that the absorber can deflect to conform with the arcuate configuration of the beam.

In the present invention the cells desirably are formed of a resilient moldable resin. While more expensive resins can be employed with perhaps improved characteristics, high density polyethylene (HDPE), preferably with a rubber modifier, is an acceptable material and is relatively inexpensive.

The cells of the absorber are formed with circular side walls 30, a top 32, and an open bottom 34 formed in a base 20. The absorber can be formed by injection molding or by other known processes. The walls 30 can be formed as a substantially right circular cylinder, but for injection molding purposes, the walls are tapered somewhat inwardly from the base to the top of the cells. The inward taper not only is desirable for molding purposes, but it provides a desirable cell collapse pattern when the cells are subjected to an impact load.

The base or base sheet 20 is preferably formed at the ends of the cells, as shown in FIG. 1. Alternatively, the base could be at an intermediate position on the cell, as shown by base 20′ in FIG. 8. This is somewhat more difficult to mold and may be less desirable.

The construction of the energy absorber of the present invention is discussed in detail in applicant's copending patent application referred to above, which is incorporated by reference. In this construction, the cells employ relatively thin side walls and have a height almost twice as high as the width or diameter of the cells. The same absorber employed in applicant's copending application can be employed inside the beam as well as outside the beam. Desirably, cells having a wall thickness of less than about 2 mm and preferably about 1 mm are employed in a cell having a height of approximately 58 mm and a diameter of about 32 mm. This produces an aspect ratio of height to width to wall thickness of about 1.8. Some variation is possible in these parameters.

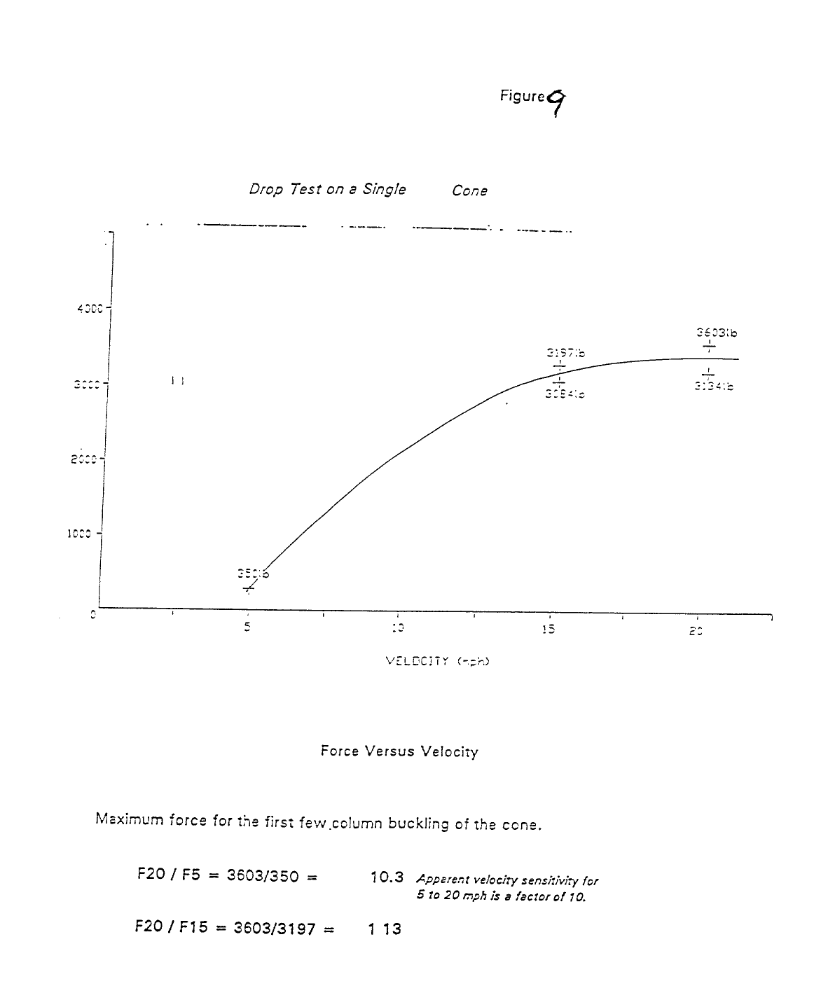

The desirability of the cup-shaped bumpers employing thin wall construction of the present invention is that the cups collapse axially and resist tearing along the side walls when subjected to impact loads, even though the walls are quite thin. The thinness of the walls provides more flexibility for the walls and it also permits the walls to collapse to a greater extent between the fully extended and fully collapsed positions of the cells. In the present invention, for high speed impacts, the absorber is capable of approximately 85% collapse, with slow recovery and true energy absorption. The absorber has very desirable force versus displacement and force versus velocity characteristics, as shown in FIGS. 7 and 9.

The absorber may run the entire length of the beam or it may be employed at strategic locations over the ends of the rails or the ends of the beams or at the center of the beam, where the absorber can resist the impact of a pole.

With the beam construction of the present invention, the internal bumper beam absorber reinforces the beam and makes it possible to use a beam having a thinner side wall. While hollow extruded aluminum is desirable, the bumper can also be formed of steel or a composite or other rigid member.

The internal bumper beam absorber substantially improves the energy absorbing and crush resistance of the bumper beam and hence the bumper system itself. When a bumper beam is not internally reinforced, the bumper beam tends to resist collapse up to a certain point and then collapse quickly until it is flat with little additional energy absorption. With an internal bumper beam absorber of the type provided in the present invention, when a bumper beam is subjected to a high speed collision, the collapse is gradual, with a high rate of energy absorption through substantially the whole distance of collapse. This provides a substantial advantage and does not require any additional cushioning space at the end of the vehicle but instead uses the internal space in the beam.

It should be understood that the foregoing is merely exemplary of the present invention and that various changes in the details of the embodiments disclosed herein may be made without departing from the spirit and scope of the present invention.

I claim:

1. In a motor vehicle comprising one or more bumpers the improvement comprising an impact energy absorber mounted to the bumper in position to cushion a horizontal impact load directed against the bumper, the impact energy absorber being integrally formed of a material comprising a resilient, moldable plastic resin and comprising a base sheet having a plurality of spaced, inverted cup-shaped energy absorbing cells integrally formed therein, the cells having a top end positioned away from the base sheet and an open bottom end and having a relatively thin side wall extending downwardly and outwardly between the top and the bottom, the cells having a generally circular cross-section and being resiliently collapsible in an axial direction when subjected to an axial impact load, the cup-shaped cells extending in a generally horizontal direction in position to receive the impact load, the energy absorber being constructed and mounted such that the energy absorption of the energy absorber is attributable substantially exclusively to the resilient collapse of the cell side walls and not to air compression inside the cells.

2. A vehicle according to claim 1 wherein the absorber comprises cells that are approximately twice as high as they are wide.

3. A vehicle component according to claim 1 wherein the absorber comprises cells wherein the aspect ratio of cell height to width to side wall thickness is approximately the same as a cell having a height of approximately 58 mm, a width of approximately 32 mm, and a side wall thickness of approximately one millimeter.

4. A vehicle component according to claim 1 wherein the absorber comprises cells wherein the aspect ratio of the height to width to thickness of the cells is approximately 1:8.

5. A vehicle component according to claim 2 wherein the absorber comprises cells that are approximately 58 mm high, 32 mm wide at the top end, 33 mm wide at the bottom end, and one millimeter thick.

6. A vehicle component according to claim 1 wherein the absorber comprises cells wherein the cell side walls are inclined outwardly only slightly from the tops to the bottoms of the cells.

7. A vehicle component according to claim 1 wherein the diameter of the inclined cells increases from the top to the bottom of the cells by an amount approximately proportional to a diameter increase of about one millimeter over a cell height of about 58 mm.

8. A vehicle according to claim 1 wherein the energy absorber comprises a thermoplastic polyolefin resin.

9. A vehicle according to claim 1 wherein the energy absorber comprises a material having energy absorber properties at least comparable to high density polyethylene (HDPE).

10. A vehicle according to claim 9 wherein the material comprises high density polyethylene (HDPE).

11. A vehicle according to claim 1 wherein the energy absorber is formed by injection molding and includes reinforcing ribs that extend along and connect at least some of the cells, so as to reinforce the cells against lateral forces.

12. A vehicle according to claim 1 wherein the energy absorber includes horizontal and vertical axially extending ribs interconnecting adjacent cells.

13. A vehicle according to claim 1 wherein the bumper comprises a rigid but deformable hollow beam member having an opening in the interior thereof that is sized such that the absorber fits in the opening and extends between front and back panels of the beam that are positioned on opposite sides of the opening, the absorber serving to absorb energy and provide crush resistance to the bumper beam.

14. A vehicle according to claim 13 wherein the beam is an extruded member having a continuous outer periphery, with the front and back panels being generally vertical when the beam is mounted on the vehicle.

15. A vehicle according to claim 14 wherein the beam is formed of one or more materials consisting of aluminum and steel.

16. A vehicle according to claim 14 wherein the beam comprises extruded aluminum.

17. A vehicle according to claim 13 wherein the opening in the beam is sized to fit relatively closely over the absorber, and the beam includes positioning members on the interior of the opening that snugly engage the absorber and hold it in place in the opening.
